(19) United States
(12) Patent Application Publication
(10) Pub. No.: US 2018/0012068 A1
(43) Pub. Date: Jan. 11, 2018

(54) MOVING OBJECT DETECTION DEVICE, IMAGE PROCESSING DEVICE, MOVING OBJECT DETECTION METHOD, AND INTEGRATED CIRCUIT

(71) Applicant: PANASONIC INTELLECTUAL PROPERTY MANAGEMENT CO., LTD., Osaka (JP)

(72) Inventors: Yuya TANAKA, Kyoto (JP); Yoshihito OHTA, Osaka (JP); Kenji TAKITA, Osaka (JP)

(73) Assignee: PANASONIC INTELLECTUAL PROPERTY MANAGEMENT CO., LTD., Osaka (JP)

(21) Appl. No.: 15/714,102

(22) Filed: Sep. 25, 2017

Related U.S. Application Data
(63) Continuation of application No. PCT/JP2016/000122, filed on Jan. 12, 2016.

(30) Foreign Application Priority Data
Mar. 26, 2015 (JP) 2015-064941

(51) Int. Cl. G06K 9/00; G08G 1/16; B60R 1/00

(52) U.S. Cl. CPC G06K 9/00369; B60R 1/00; G08G 1/166; G06T 7/215; B60R 2300/307; G06T 2207/30196; G06T 2207/30261; B60R 2300/8033

(57) ABSTRACT

A moving object detection device includes: an image capturing unit with which a vehicle is equipped, and which is configured to obtain captured images by capturing views in a travel direction of the vehicle; a setting unit configured to set, for each of frames that are the captured images, a movement vanishing point at which movement of a stationary object in the captured images due to the vehicle traveling does not occur; a calculation unit configured to calculate, for each of unit regions of the captured images, a first motion vector indicating movement of an image in the unit region; and a detection unit configured to detect a moving object present in the travel direction, based on the movement vanishing points set by the setting unit and the first motion vectors calculated by the calculation unit.

### CROSS REFERENCE TO RELATED APPLICATIONS

This is a continuation application of PCT International Application No. PCT/JP2016/000122 filed on Jan. 12, 2016, designating the United States of America, which is based on and claims priority of Japanese Patent Application No. 2015-064941 filed on Mar. 26, 2015. The entire disclosures of the above-identified applications, including the specifications, drawings and claims are incorporated herein by reference in their entirety.

### FIELD

The present disclosure relates to a moving object detection device, an image processing device, and a moving object detection method.

### BACKGROUND

A traditional technique of detecting, for instance, a pedestrian present in the vicinity of a vehicle, and controlling the vehicle according to the result of the detection has been known. For example, Patent Literature (PTL) 1 discloses a technique of identifying an object such as a pedestrian by performing processing such as pattern matching on an image obtained by an on-board image capturing device.

### CITATION LIST

### Patent Literature

### [PTL 1] Japanese Unexamined Patent Application Publication No. 2007-58751

### SUMMARY

### Technical Problem

The present disclosure provides a moving object detection device which can detect a moving object from an image captured by an on-board camera of a vehicle in motion, an image processing device, and a moving object detection method.

### Solution to Problem

The moving object detection device according to the present disclosure includes: an image capturing unit with which a vehicle is equipped, and which is configured to obtain captured images by capturing views in a travel direction of the vehicle; a calculation unit configured to calculate, for each of unit regions of the captured images, a first motion vector indicating movement of an image in the unit region; and a detection unit configured to detect a moving object present in the travel direction, based on a movement vanishing point at which movement of a stationary object in the captured images due to the vehicle traveling does not occur and the first motion vectors calculated by the calculation unit.

### Advantageous Effects

According to the present disclosure, a moving object can be detected from an image captured by an on-board camera of a vehicle in motion.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a block diagram illustrating a functional configuration of a moving object detection device according to an embodiment.

FIG. 2 is a diagram illustrating a vehicle equipped with the moving object detection device according to the embodiment.

FIG. 3 is a diagram illustrating a captured image according to the embodiment.

FIG. 4 is an explanatory diagram illustrating processing of calculating a motion vector for each block of a captured image according to the embodiment.

FIG. 5 is a diagram illustrating a movement vanishing point and motion vectors of stationary objects according to the embodiment.

FIG. 6 is an explanatory diagram illustrating processing of detecting a moving object according to the embodiment.

FIG. 7 is a flow chart illustrating operation (moving object detection method) of the moving object detection device according to the embodiment.

### DESCRIPTION of Embodiments

The following describes in detail embodiments with reference to the drawings as appropriate. However, an unnecessarily detailed description may be omitted. For example, a detailed description of a matter already known well and a redundant description of substantially the same configuration may be omitted. This is intended to avoid making the following description unnecessarily redundant and to facilitate understanding of a person skilled in the art.

Note that the inventors provide the accompanying drawings and the following description in order that a person skilled in the art sufficiently understands the present disclosure, and thus do not intend to limit the subject matter of the claims by the drawings and the description, The embodiments described below each show a particular example of the present disclosure. The numerical values, shapes, materials, elements, the arrangement and connection of the elements, steps, the processing order of the steps, and the like described in the following embodiments are examples, and thus are not intended to limit the technology in the present disclosure. Therefore, among the elements in the following embodiments, elements not recited in any of the independent claims defining the most generic concept of the present disclosure are described as arbitrary elements.

The drawings are schematic diagrams, and thus do not necessarily provide strictly accurate illustration. Furthermore, the same numeral is given to the same element throughout the drawings,

### EMBODIMENT

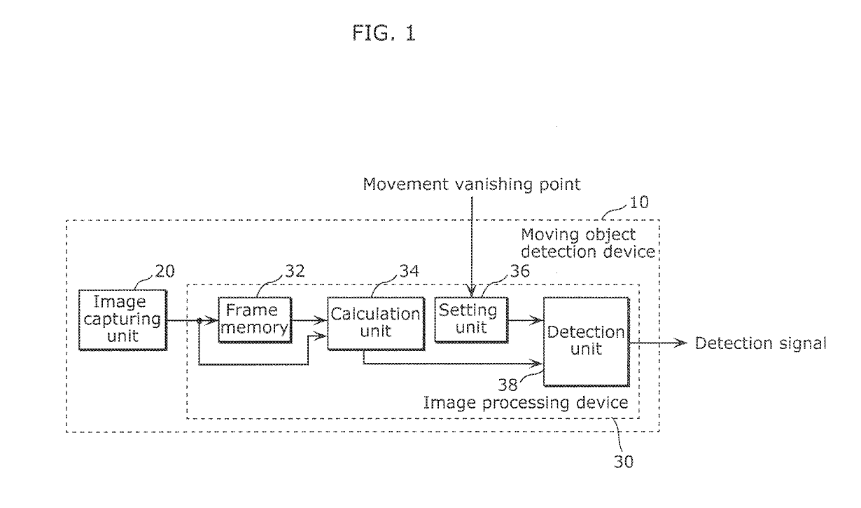

The following describes, for instance, a moving object detection device according to the embodiment, with reference to FIGS. 1 to 7.

### 1. Configuration

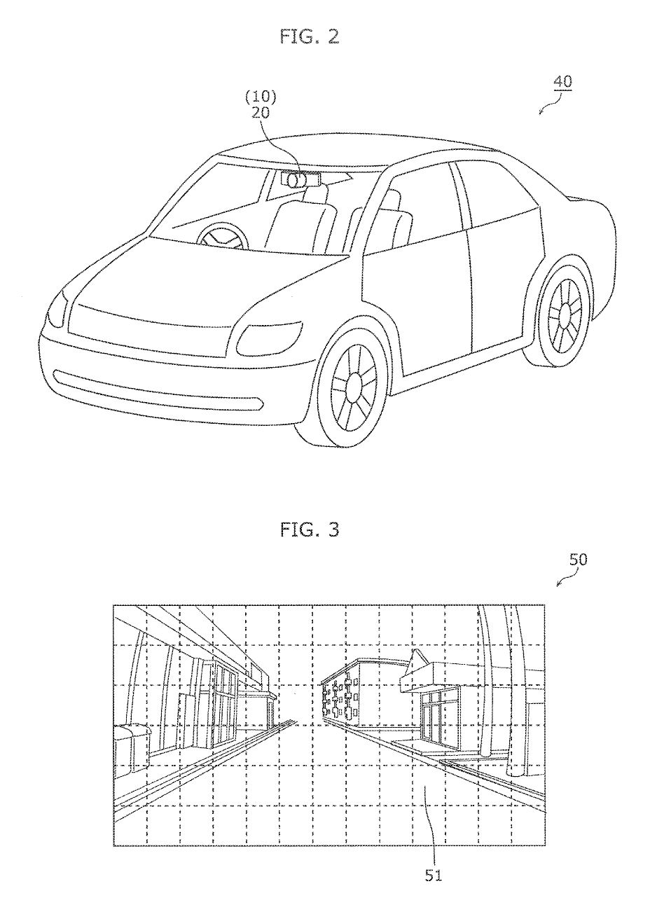

FIG. 1 is a block diagram illustrating a functional configuration of a moving object detection device 10 according to the present embodiment. FIG. 2 is a diagram illustrating a vehicle 40 equipped with the moving object detection device 10 according to the present embodiment. The moving object detection device 10 includes an image capturing unit 20 and an image processing device 30 as illustrated in FIG. 1.

The image capturing unit 20 is provided in the vehicle 40 as illustrated in FIG, 2. The image capturing unit 20 captures a view in the travel direction of the vehicle 40, to obtain a captured image. Specifically, the image capturing unit 20 captures a view in the travel direction of the vehicle 40 while the vehicle 40 is moving (in motion) in the travel direction, to obtain a captured image. More specifically, the image capturing unit 20 captures an image of a space outside of the vehicle 40 in the travel direction, that is, a space ahead of the vehicle 40, for example. Captured images constitute a video which includes a plurality of frames.

The image capturing unit 20 is an on-board camera, and is attached to the ceiling of the vehicle 40, or the upper surface of a dashboard, for example. Accordingly, the image capturing unit 20 captures a view ahead of the vehicle 40. Note that the image capturing unit 20 may be attached to the outside of the vehicle 40, rather than the inside thereof.

The image processing device 30 is for detecting a moving object present in the travel direction of the vehicle 40, using captured images obtained by the image capturing unit 20. The image processing device 30 is achieved by, for example, a microcomputer which includes a program, a memory, and a processor. The vehicle 40 may be equipped with the image processing device 30 that is achieved integrally with the image capturing unit 20 or separately from the image capturing unit 20, for example.

The image processing device 30 includes a frame memory 32, a calculation unit 34, a setting unit 36, and a detection unit 38 as illustrated in FIG. 1.

The frame memory 32 is a memory for storing captured images obtained by the image capturing unit 20. The frame memory 32 stores a captured image for one frame, for example. The frame memory 32 is a volatile memory, for example.

The calculation unit 34 calculates, for each of unit regions of a captured image, a first motion vector indicating movement of an image in the unit region. The first motion vector indicates a direction in which and how much the image in the unit region has moved. The unit region is a block made up of one or more pixels. A block is, for example, a rectangular region, and is a group of 8×8 pixels, which is an example.

Specifically, the calculation unit 34 divides a captured image 50 into a plurality of blocks 51, as shown in FIG. 3. Note that FIG. 3 is a diagram illustrating a captured image 50 according to the present embodiment. In the present embodiment, the calculation unit 34 divides the captured image 50 into blocks 51 in M rows and N columns, In other words, the blocks 51 are unit regions obtained by dividing the captured image 50 into rows and columns. Note that M and N each represent a natural number of 2 or more.

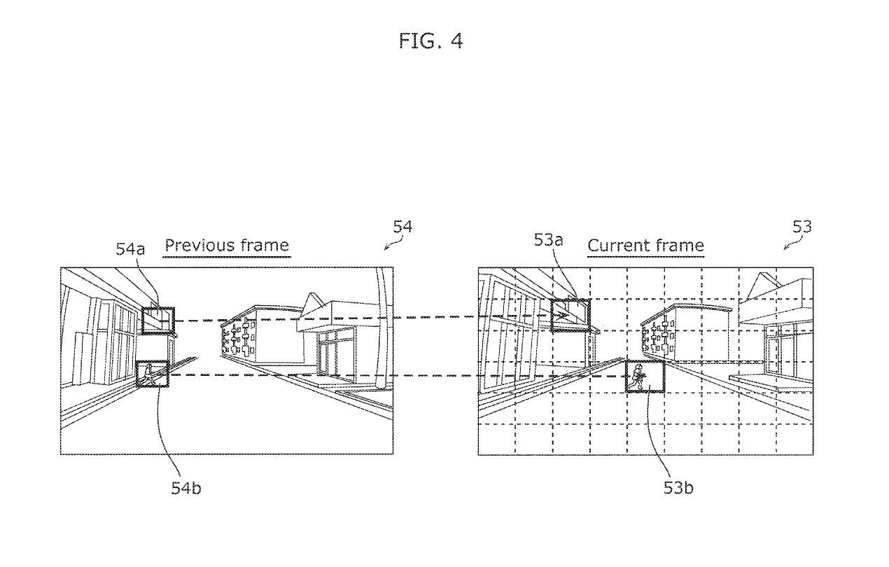

FIG. 4 is an explanatory diagram illustrating processing of calculating a motion vector for each block of a captured image according to the present embodiment. The calculation unit 34 calculates a first motion vector of each block 51 in a frame, by block matching between frames which are captured images. For example, the calculation unit 34 searches for the most matching blocks by performing, for each block 51 in a current frame 53 and a previous frame 54, evaluation in which a distance function is used, such as calculating an absolute error or a square error of values of pixels included in blocks 51 in the same relative position of the current frame 53 and the previous frame 54, as illustrated in FIG. 4.

For example, the result of block matching shows that a block 53a and a block 53b in the current frame 53 correspond to a block 54a and a block 54b in the previous frame 54, respectively. A vector indicating an amount and a direction of movement from the block 54a to the block 53a corresponds to a first motion vector of the block 53a. The same applies to the first motion vector of the block 53b.

Note that the current frame 53 is input from the image capturing unit 20 to the calculation unit 34. The previous frame 54 is currently held in the frame memory 32 and is, for example, a frame immediately previous to the current frame 53. The current frame 53 and the previous frame 54 are, for example, two frames successive in the capturing order (input order) among a plurality of frames which are captured images, but are not limited to such successive frames. For example, it is sufficient if the previous frame 54 is a frame captured previously to the current frame 53, and thus the previous frame 54 may be a frame captured previously to the current frame 53 by two or more frames. Note that the calculation unit 34 may use a frame captured after the current frame 53 is captured, instead of the previous frame 54.

The setting unit 36 sets a movement vanishing point which is to be used to detect a moving object. A movement vanishing point is a point at which movement of stationary objects due to the vehicle 40 traveling does not occur. Specifically, a movement vanishing point is a point at which lines extending from the start points of motion vectors of stationary objects that occur in a captured image converge when an observer (here, the vehicle 40) makes a translation motion. For example, when a camera (the image capturing unit 20) is disposed such that the optic axis is parallel to the ground contact surface of the vehicle 40 and the travel direction of the vehicle 40, the movement vanishing point when the vehicle 40 is traveling straight ahead substantially matches the center of a captured image, In the present embodiment, the movement vanishing point is predetermined. For example, the setting unit 36 sets an approximate center of a captured image as a movement vanishing point.

A stationary object is an object at rest in a real space. Stationary objects correspond to, for example, backgrounds such as ground (roads), sky, and structures including traffic lights, vehicle guard fences (crash barriers), and buildings. Note that stationary objects may include objects which slightly move due to, for instance, winds, such as a roadside tree and a cable. Specifically, a stationary object may be an object whose amount of movement is regarded or can be regarded as 0.

A moving object is an object moving in a real space. Examples of moving objects include animals such as persons and pets, and vehicles such as motorcycles and cars. Note that moving objects may also include unfixed objects such as garbage cans and standing signboards.

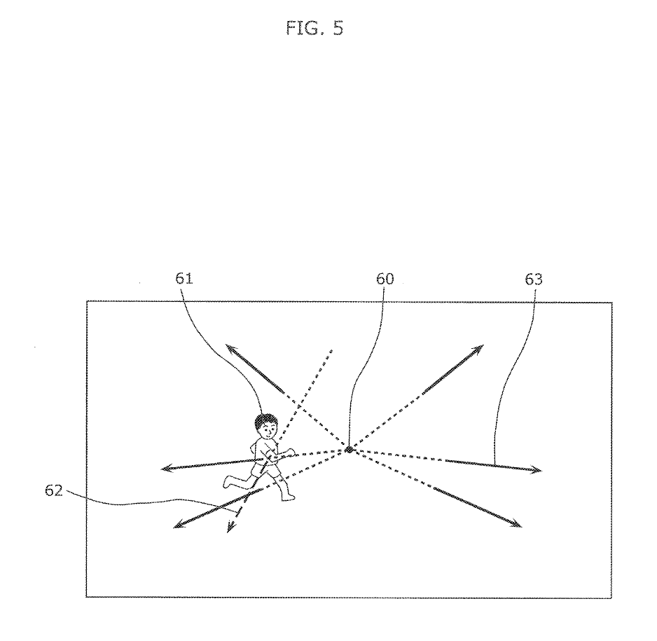

FIG. 5 illustrates a movement vanishing point and motion vectors in the present embodiment. FIG. 5 illustrates a movement vanishing point 60, a moving object 61, and motion vectors 62 and 63.

The motion vectors 62 and 63 are first motion vectors calculated by the calculation unit 34 for blocks 51. The motion vector 62 is a first motion vector of a block in which the moving object 61 is present. The motion vector 63 is a first motion vector of a block in which the moving object 61 is not present. Stated differently, the motion vector 63 corresponds to a motion vector of a stationary object which has occurred in a captured image due to the vehicle 40 traveling.

In the present embodiment, the setting unit 36 sets an approximate center of a captured image as the movement vanishing point 60. At this time, lines extending from the start points of motion vectors 63 other than the motion vector 62 converge on the movement vanishing point 60, as illustrated by the solid arrows in FIG. 5. Stated differently, motion vectors of stationary objects are spread, extending radially from the movement vanishing point 60.

As described above, lines extending from the start points of motion vectors of stationary objects (motion vectors 63) converge on the movement vanishing point 60, whereas a line extending from the start point of a motion vector (motion vector 62) of a block in which the moving object 61 is present does not converge on the movement vanishing point 60. Accordingly, a block in which the moving object 61 is present can be detected by determining whether a line extending from the start point of a motion vector converge on the movement vanishing point 60.

The detection unit 38 detects a moving object present in a travel direction, based on the movement vanishing point and the first motion vectors calculated by the calculation unit 34. Specifically, the detection unit 38 detects a moving object, based on the movement vanishing point set by the setting unit 36 and the first motion vectors calculated by the calculation unit 34.

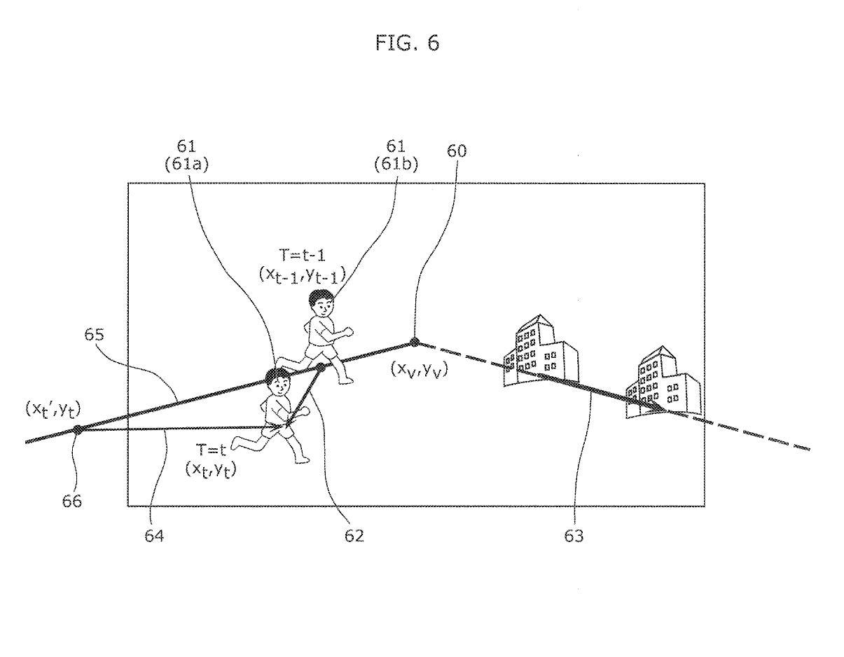

For example, the detection unit 38 detects a moving object by calculating a second motion vector indicating movement of a moving object in a real space, using a straight line passing through the movement vanishing point and the start point of a first motion vector, and the end point of the first motion vector. Specifically, for each block 51, the detection unit 38 calculates, as the second motion vector, a vector having: a predetermined direction; an end point located at the end point of a first motion vector; and a start point located at an intersection of the vector and a straight line which connects the movement vanishing point to the start point of the first motion vector. Specifically, the predetermined direction is a lateral direction in a captured image. More specifically, the predetermined direction corresponds to a horizontal direction (lateral direction) in a real space. For example, the second motion vector is a motion vector 64 illustrated in FIG. 6.

FIG. 6 is an explanatory diagram of processing of detecting a moving object 61 according to the present embodiment. In FIG. 6, a moving object 61a indicates the position of the moving object 61 at time t (current frame 53). A moving object 61b indicates the position of the moving object 61 at time t-1 (previous frame 54). Here, a method of calculating the second motion vector of the moving object 61 in a block in which the moving object 61a is present is described.

The x axis and the y axis are set corresponding to the horizontal direction and the vertical direction, respectively, in a captured image. A block (or pixel) in a captured image is expressed using an x coordinate and a y coordinate. For example, the coordinates of the movement vanishing point are expressed by (xᵥ, yᵥ).

First, the detection unit 38 calculates the start point of a motion vector 62 (first motion vector) of a block which includes the moving object 61a. The start point corresponds to the position of a block which includes the moving object 61b, namely, the position of a block in which the moving object 61 is present in the previous frame 54. Here, the coordinates of the start point of the first motion vector 62 are expressed by (xₜ₋₁, yₜ₋₁).

Next, the detection unit 38 calculates an expression that indicates a straight line 65 passing through the movement vanishing point 60 and the start point of the motion vector 62. For example, the straight line 65 is expressed by y=px+q (Expression 1), and thus coefficients p and q are calculated by substituting coordinates (xᵥ, yᵥ) of the movement vanishing point 60 and coordinates (xₜ₋₁, yₜ₋₁) of the start point into Expression 1.

Next, the detection unit 38 calculates an x coordinate xt′ of a predetermined point 66 on the straight line 65 by substituting a y coordinate yₜ at the end point of the first motion vector 62 into Expression 1 for which the coefficients p and q are calculated. The detection unit 38 calculates the motion vector 64 whose start point is located at the predetermined point 66 and whose end point is located at the end point of the motion vector 62, as the second motion vector indicating movement of the moving object 61 in the real space.

Here, the y coordinate of the predetermined point 66 is the same as the y coordinate of the end point of the motion vector 62, and thus the direction of the motion vector 64 is parallel to the x-axis direction, that is, the lateral direction in the captured image. The magnitude of the motion vector 64, namely, a difference (absolute value) between the x coordinate of the end point of the motion vector 62 and the x coordinate of the predetermined point 66 corresponds to the amount of movement of the moving object 61. Thus, according to the present embodiment, the amount of movement of the moving object 61 in the lateral direction in the real space can be calculated.

Note that in the case of a stationary object, the motion vector 62 matches the straight line 65, and thus a difference (absolute value) between the x coordinate of the end point of the motion vector 62 and the x coordinate of the predetermined point 66 is 0. Accordingly, the magnitude of the motion vector 64 is 0.

For example, when the magnitude of the motion vector 64 (second motion vector) of a block is greater than a predetermined threshold, the detection unit 38 determines that the moving object 61 is present in the block. The detection unit 38 can detect a block 51 in which a moving object is present in a captured image, by determining, for each block 51, whether the magnitude of the motion vector 64 of the block 51 is greater than the predetermined threshold. Accordingly, the detection unit 38 detects a moving object which is present in a region corresponding to the detected block 51 in the real space.

The predetermined threshold may be, for example, a fixed value for all the regions of a captured image, or may vary depending on the position of a block 51. For example, a low threshold may be used for a block 51 at or near the center of a captured image, or a high threshold may be used for a block 51 distant from the center of a captured image.

If the magnitude of the second motion vector is greater than the threshold, it is meant that the moving object 61 is to enter the route in the travel direction of the vehicle 40 (in other words, a region where the vehicle 40 is to advance), or in other words, there will be danger. Therefore, the danger for the vehicle 40 can be perceived by the detection unit 38 detecting the moving object 61. Accordingly, control for avoiding danger can be performed, for example.

In the present embodiment, the detection unit 38 outputs a detection signal if the detection unit 38 detects a moving object. Specifically, a detection signal is output to, for instance, a brake control unit or a notification unit of the vehicle 40. For example, the brake control unit decelerates the vehicle 40, based on the detection signal. For example, the notification unit produces, for instance, a warning beep or shows an alarm display, based on the detection signal, thus notifying a driver or a moving object (for example, a child running out) of the danger. This provides driving support to avoid danger, for instance.

### 2. Operation (Moving Object Detection Method)

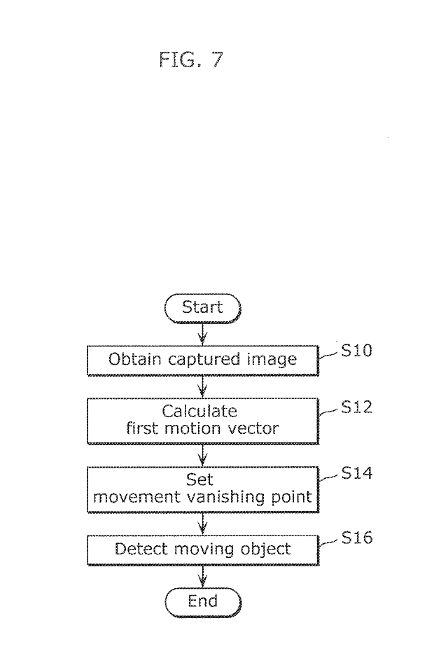

FIG. 7 is a flow chart illustrating operation (moving object detection method) of the moving object detection device 10 according to the present embodiment. First, the image capturing unit 20 obtains a captured image (video) by capturing a view in the travel direction of the vehicle 40 (S10: image capturing step). A captured image is stored in the frame memory 32 and input to the calculation unit 34, frame-by-frame, for example,

Next, the calculation unit 34 calculates, for each block 51 of a captured image, a first motion vector indicating movement of an image in the block 51 (S12: calculation step). Specifically, the calculation unit 34 performs block matching for each block 51, using the current frame 53 input from the image capturing unit 20 and the previous frame 54 read from the frame memory 32, thus calculating the first motion vector of the block 51.

Next, the setting unit 36 sets a movement vanishing point (S14: setting step). Note that since the movement vanishing point is a fixed point in the present embodiment, this setting may be omitted.

Next, the detection unit 38 detects a moving object present in the travel direction, based on the movement vanishing point and the first motion vectors calculated in the calculation step (S16: detection step). Specifically, the detection unit 38 calculates, for each block 51, a second motion vector indicating the movement of a moving object in the real space, based on the straight line 65 passing though the movement vanishing point 60, and the first motion vector (motion vector 62), as described with reference to FIG. 6. The detection unit 38 determines, for each block 51, whether a moving object is. present in the block 51, based on the magnitude of the second motion vector calculated for the block 51. For example, when the magnitude of the second motion vector of a block 51 is greater than the predetermined threshold, the detection unit 38 determines that a moving object is present in the block 51.

Accordingly, the moving object 61 which is moving toward the route in the travel direction of the vehicle 40 can be detected, as illustrated in FIG. 6, for example. Therefore, for example, a child running out can be detected and danger assessment can be conducted.

### 3. Advantageous Effects and Others

As described above, the moving object detection device 10 according to the present embodiment includes: an image capturing unit 20 with which a vehicle 40 is equipped, and which is configured to obtain captured images by capturing views in a travel direction of the vehicle 40; a calculation unit 34 configured to calculate, for each of blocks of the captured images, a first motion vector indicating movement of an image in block; and a detection unit 38 configured to detect a moving object present in the travel direction, based on a movement vanishing point at which movement of a stationary object in the captured images due to the vehicle 40 traveling does not occur and the first motion vectors calculated by the calculation unit 34.

According to a traditional technology, a moving object may not be detected from a captured image, depending on an environment where a vehicle is traveling. For example, when a moving object is moving parallel to the vehicle, or when a moving object is moving in a direction perpendicular to the vehicle, a motion vector of the moving object relative to the vehicle is 0, and thus the moving object cannot be recognized as an object that is in motion.

In view of this, according to the moving object detection device 10 according to the present embodiment, the movement vanishing point and a motion vector calculated for each block of the captured image are used, and thus a moving object can be detected from a captured image obtained by the vehicle 40 in motion. Specifically, a motion vector of a moving object can be calculated by eliminating a motion vector component of a stationary object estimated from the motion vector of the captured image, based on the movement vanishing point. Accordingly, a moving object present in the travel direction of the vehicle 40 can be detected accurately.

For example, in the present embodiment, the detection unit 38 detects the moving object by calculating, for each of the blocks, a vector as a second motion vector indicating movement of the moving object in a real space, the vector having: a predetermined direction; an end point located at an end point of the first motion vector; and a start point located at an intersection of the vector and a straight line which connects a start point of the first motion vector to the movement vanishing point.

Accordingly, the second motion vector can be detected accurately, and thus the accuracy of detecting a moving object can be further increased.

For example, in the present embodiment, the predetermined direction is a lateral direction in the captured images.

Accordingly, a moving object which moves, in a real space, in a lateral direction relative to the travel direction can be detected. For example, a child running out from an edge of a road can be detected, and thus danger for the vehicle 40 can be perceived. Accordingly, control for avoiding danger can be performed, for example.

The moving object detection method according to the present embodiment includes: obtaining captured images by capturing views in a travel direction of the vehicle 40; calculating, for each of blocks of the captured images, a motion vector indicating movement of an image in the block; and detecting a moving object present in the travel direction, based on a movement vanishing point at which movement of a stationary object in the captured images due to the vehicle 40 traveling does not occur and the motion vectors calculated for the blocks.

Accordingly, a moving object can be detected from a captured image obtained by the on-board camera provided in the vehicle 40 in motion.

The image processing device and the integrated circuit according to the present embodiment each include: a calculation unit 34 configured to calculate, for each of blocks of captured images obtained by an image capturing device capturing views in a travel direction of a vehicle 40 which is equipped with the image capturing device, a motion vector indicating movement of an image in the block; and a detection unit 38 configured to detect a moving object present in the travel direction, based on a movement vanishing point at which movement of a stationary object in the captured images due to the vehicle 40 traveling does not occur and the motion vectors calculated by the calculation unit 34.

Accordingly, a moving object can be detected from a captured image obtained by the on-board camera provided in the vehicle 40 in motion.

### 4. Variation

The present embodiment has described an example in which the setting unit 36 sets a predetermined movement vanishing point, or stated differently, the movement vanishing point is a fixed point, but the present disclosure is not limited to this. The movement vanishing point changes according to the traveling state of the vehicle 40.

For example, when the vehicle 40 is traveling straight forward, the movement vanishing point substantially matches the center of a captured image. When the vehicle 40 is traveling along a right curve, the movement vanishing point is located on the right relative to the center of the captured image. When the vehicle 40 is traveling along a left curve, the movement vanishing point is located on the left relative to the center of the captured image. Note that the movement vanishing point may be present outside the captured image.

Specifically, the setting unit 36 may set the movement vanishing point for each of frames that are captured images. For example, the setting unit 36 may estimate motion vectors of stationary objects from a captured image, and set, as the movement vanishing point, a point on which lines extending from the start points of the estimated motion vectors converge.

A motion vector of a stationary object is a vector indicating movement of a stationary object which has occurred in the captured image due to the vehicle 40 traveling. The motion vector of a stationary object is estimated based on robust estimation according to which, for example, stationary objects are assumed to dominantly occupy the captured image. Random Sample Consensus (RANSAC) can be used as robust estimation, for example. Accordingly, a motion vector of a stationary object can be estimated while excluding the moving object in the captured image.

Thus, according to this variation, for example, the moving object detection device 10 includes the setting unit 36 which sets, for each of frames that are the captured images, a movement vanishing point, and the detection unit 38 detects a moving object, based on the movement vanishing points set by the setting unit 36 and the first motion vectors calculated by the calculation unit.

Accordingly, the movement vanishing point is set for each frame, and thus the accuracy of the movement vanishing point can be increased. The accuracy of detecting a moving object can be, therefore, further increased.

Note that the technology in the present disclosure can be achieved not only as the moving object detection device, the image processing device, and the moving object detection method, but also as a program which includes the moving object detection method and/or the image processing method as steps, and a computer-readable recording medium such as a digital versatile disc (DVD) in which the program is stored.

Thus, the general or particular aspect described above may be achieved as a system, a device, an integrated circuit, a computer program, or a computer-readable recording medium, or may be achieved as an arbitrary combination of systems, devices, integrated circuits, computer programs, or computer-readable recording media.

### OTHER EMBODIMENTS

This completes description of the embodiment, as an example of the technology disclosed in the present application. However, the technology according to the present disclosure is not limited to this, and is also applicable to embodiments as a result of appropriate modification, replacement, addition, and omission, for instance.

The following describes other embodiments.

For example, the above embodiment has described an example in which the calculation unit 34 calculates a motion vector using two captured images, yet the present disclosure is not limited to this. For example, the calculation unit 34 may calculate a motion vector using three or more captured images. Accordingly, a more highly accurate motion vector can be calculated, and thus the accuracy of detecting a moving object can be increased. Note that in this case, the image processing device 30 may include a plurality of frame memories 32, for example. Alternatively, the frame memory 32 may store two or more frames Of captured images.

For example, the above embodiment has described an example in which the direction of a second motion vector is a lateral direction in a captured image, yet the present disclosure is not limited to this. Specifically, the detection unit 38 substitutes the y coordinate of the end point of the motion vector 62 (first motion vector) when calculating the coordinates of the predetermined point 66, yet the detection unit 38 may calculate, as the predetermined point 66, an intersection of the straight line 65 and a predetermined straight line passing through the end point of the motion vector 62.

For example, although the above embodiment has described the case where the travel direction of the vehicle 40 is frontward of the vehicle 40, but ay be backward of the vehicle 40. Specifically, the vehicle 40 may travel backward (be reversed), and in this case, the image capturing unit 20 may capture a view behind the vehicle 40. For example, the image capturing unit 20 may change the direction in which images are captured, or another capturing unit which captures a backward view may be attached to the vehicle 40.

For example, the above embodiment has described an example in which the vehicle 40 is equipped with the image processing device 30, yet the present disclosure is not limited to this. The image processing device 30 may be, for instance, a server apparatus provided separately from the vehicle 40, and obtain a captured image via a network from the image capturing unit 20 (on-board camera) with which the vehicle 40 is equipped. Alternatively, the image processing device 30 may obtain a captured image obtained by the on-board camera and stored in, for instance, a recording medium, by reading the captured image from the recording medium, for instance.

The above has described embodiments as examples of the technology according to the present disclosure. For the description, the accompanying drawings and the detailed description are provided.

Thus, the elements illustrated in the accompanying drawings and described in the detailed description may include not only elements necessary for addressing problems, but also elements not necessarily required for addressing the problems, in order to illustrate the above technology. Accordingly, a fact that such unnecessarily required elements are illustrated in the accompanying drawings and described in the detailed description should not immediately lead to a determination that such unnecessarily required elements are required.

In addition, the embodiments described above are intended to illustrate the technology according to the present disclosure, and thus various modifications, replacement, addition, and omission, for instance, can be performed within the scope of claims and equivalent thereof.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure,

### INDUSTRIAL APPLICABILITY

The moving object detection device, the image processing device, and the moving object detection method according to the present disclosure are applicable to an on-board camera, for example.

1. A moving object detection device comprising:
an image capturing unit with which a vehicle is equipped, and which is configured to obtain captured images by capturing views in a travel direction of the vehicle;
a setting unit configured to set, for each of frames that are the captured images, a movement vanishing point at which movement of a stationary object in the captured images due to the vehicle traveling does not occur;
a calculation unit configured to calculate, for each of unit regions of the captured images, a first motion vector indicating movement of an image in the unit region; and
a detection unit configured to detect a moving object present in the travel direction, based on the movement vanishing points set by the setting unit and the first motion vectors calculated by the calculation unit, wherein
the detection unit detects the moving object by calculating, for each of the unit regions, a vector as a second motion vector indicating movement of the moving object in a real space, the vector having: a predetermined direction; an end point located at an end point of the first motion vector; and a start point located at an intersection of the vector and a straight line which connects a start point of the first motion vector to the movement vanishing point.

2. The moving object detection device according to claim 1, wherein
the predetermined direction is a lateral direction in the captured images.

3. A moving object detection method comprising:
obtaining captured images by capturing views in a travel direction of a vehicle;
setting, for each of frames that are the captured images, a movement vanishing point at which movement of a stationary object in the captured images due to the vehicle traveling does not occur;
calculating, for each of unit regions of the captured images, a first motion vector indicating movement of an image in the unit region; and
detecting a moving object present in the travel direction, based on the movement vanishing points set for the frames and the first motion vectors calculated for the unit regions, wherein
the moving object is detected by calculating, for each of the unit regions, a vector as a second motion vector indicating movement of the moving object in a real space, the vector having: a predetermined direction; an end point located at an end point of the first motion vector; and a start point located at an intersection of the vector and a straight line which connects a start point of the first motion vector to the movement vanishing point.

4. An image processing device comprising:
a setting unit configured to set a movement vanishing point for each of frames that are captured images obtained by an image capturing device capturing views in a travel direction of a vehicle which is equipped with the image capturing device, the movement vanishing point being a point at which movement of a stationary object in the captured images due to the vehicle traveling does not occur;
a calculation unit configured to calculate, for each of unit regions of the captured images, a first motion vector indicating movement of an image in the unit region; and
a detection unit configured to detect a moving object present in the travel direction, based on the movement vanishing points set by the setting unit and the first motion vectors calculated by the calculation unit, wherein
the detection unit detects the moving object by calculating, for each of the unit regions, a vector as a second motion vector indicating movement of the moving object in a real space, the vector having: a predetermined direction; an end point located at an end point of the first motion vector; and a start point located at an intersection of the vector and a straight line which connects a start point of the first motion vector to the movement vanishing point.

5. An integrated circuit comprising:
a setting unit configured to set a movement vanishing point for each of frames that are captured images obtained by an image capturing device capturing views in a travel direction of a vehicle which is equipped with the image capturing device, the movement vanishing point being a point at which movement of a stationary object in the captured images due to the vehicle traveling does not occur;
a calculation unit configured to calculate, for each of unit regions of the captured images, a first motion vector indicating movement of an image in the unit region; and
a detection unit configured to detect a moving object present in the travel direction, based on the movement vanishing points set by the setting unit and the first motion vectors calculated by the calculation unit, wherein
the detection unit detects the moving object by calculating, for each of the unit regions, a vector as a second motion vector indicating movement of the moving object in a real space, the vector having: a predetermined direction; an end point located at an end point of the first motion vector; and a start point located at an intersection of the vector and a straight line which connects a start point of the first motion vector to the movement vanishing point.
